(19) United States
(12) Patent Application Publication
(10) Pub. No.: US 2026/0121927 A1
(43) Pub. Date: Apr. 30, 2026

(54) AI-POWERED NETWORK CONFIGURATION

(71) Applicant: HEWLETT PACKARD ENTERPRISE DEVELOPMENT LP, Spring, TX (US)

(72) Inventors: SOORYAA VIGNESH THIRULOGA CHANDER, Spring, TX (US); SARGAM JAIN, Spring, TX (US); DAVID FEHLING, JR., Spring, TX (US); JOSE TELLADO, Santa Clara, CA (US)

(21) Appl. No.: 18/928,996

(22) Filed: Oct. 28, 2024

(51) Int. Cl. H04L 41/0873; H04L 41/16

(52) U.S. Cl. CPC H04L 41/0873; H04L 41/16

(57) ABSTRACT

Systems and methods are provided for determining recommendations for updating various configuration settings. For example, the system can identify devices that are currently implemented in the client network and determine an inference value for the configuration setting for the configuration setting of the new device. The system can initiate a conflict resolution process to compare the network data, the inference value for the configuration setting, and existing values for other configuration settings for other network devices in the network and, based on the conflict resolution process determining that the inference value for the configuration setting conflicts with the existing values for the other configuration settings, prevent installation of the inference value at the network device despite the minimum threshold gain for the operation of the network device.

### BACKGROUND

New devices connect to networks every day in order to communicate with each other and search for information. Some estimate that more than 50 million devices connect to the public internet each day. In private networks, client environments may have different needs for allowing connection to each network by these client devices. For example, a hospital may require an open system configuration to provide ease in connecting to the network for guests while also requiring higher security configuration settings for sharing critical patient information. Moreover, while some medical devices might not be equipped to leverage recent technologies, such as Wi-Fi 6/6E, mobile devices may benefit from advanced configuration settings.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates one example of a network configuration that may be implemented for an organization, such as a business, educational institution, governmental entity, healthcare facility or other organization.

FIG. 2 illustrates a controller with recommendation engine in communication with a set of network devices, in accordance with some examples of the disclosure.

FIG. 3 is an illustrative process for determining a default configuration of a network device, in accordance with some examples of the disclosure.

FIG. 4 illustrates a ranking of configuration settings for a network device, in accordance with some examples of the disclosure.

FIG. 5 is a user interface for providing a recommendation of a configuration setting for a network device, in accordance with some examples of the disclosure.

FIG. 6 is an example computing component that may be used to implement various features of a set of models in accordance with examples discussed herein.

FIG. 7 is a computing component that may be used to implement examples of the disclosed technology.

The figures are not exhaustive and do not limit the present disclosure to the precise form disclosed.

### DETAILED DESCRIPTION

When these devices attempt to connect to a private network (e.g., a client network that has previously on-boarded an access point, switch, gateway, or other network device), the default configuration settings for the devices newly connecting to the network may cause issues. For example, the client device may attempt to connect to the private network using a default configuration based on a 6 GHz radio band, while other devices on the network may only support a 2.4 GHz radio band. The new device can decrease its configuration setting for the band to the lower setting in order to communicate on the network.

In some examples, the default settings of the new device may be adjusted to a value that enables higher bandwidths, different modes of operation, probing thresholds, particular radio band or Wi-Fi, in order to optimize the configuration for the device in relation to the other settings in other devices. For example, when a new device is received at a private network, the device may come out of the box installed with a set of default values as configuration settings. In this instance, the configuration settings may correspond to various applications, operating systems, communication protocols, security settings, or other aspects of the client environment, and each configuration setting may correspond to different values. For example, a “Wi-Fi protocol” configuration setting may correspond to IEEE 802.11ax or IEEE 802.11ac, a “radio band” configuration setting may correspond to a 2.4 GHz, 5 GHz, or 6 GHz band, and a “security” configuration setting may correspond to various certifications including wpa2, wpa3, or opensystem. It is then up to an administrative user at the client site to make changes to the values for each of the configuration settings according to the client environment, use cases, and requirements.

In these traditional systems, however, the changes to the configuration settings may not consider conflicts between the different values of the configuration settings or identify existing issues with the configuration setting once the new version is installed. As such, while updates to the configuration setting may enable the new device to run faster or otherwise optimize its performance when the administrative user manually changes the configuration settings, they may not realize that the changed configuration setting affects communications with other devices that are pre-existing on the network.

Examples of the disclosed system determine recommendations for updating various configuration settings for client networks to avoid conflict between the existing versions of configuration settings and provide an improvement to the network overall. For example, the system can identify devices that are currently connected to the client network (e.g., by parsing data packets, etc.) and determine several optimal network configuration settings that are specific to the current devices.

The optimal network configuration settings may be determined using a trained machine learning model for each configuration setting. For example, the trained machine learning model for the configuration setting may generate an “inference value” for the configuration setting. The inference value may correspond with a version number or other value defining the type/model/version of the configuration setting. For example, a “Wi-Fi protocol” configuration setting may correspond with “IEEE 802.11ax” or “IEEE 802.11ac” inference values. The inference values may be determined by the trained machine learning model that corresponds with the configuration setting. In another example, the “radio band” configuration setting may correspond with “2.4 GHz,” “5 GHz,” or “6 GHz”inference values.

When the trained machine learning model is executed, the machine learning model may use real-time data from the network to determine an inference value for a configuration setting of a device that has been added to the network. For example, the trained machine learning model can receive the data from the network (for the configuration setting) and provide it as input to the machine learning model that is tuned to optimize values associated with the particular configuration setting. The output of the machine learning model can suggest the inference value of the configuration setting that best works for the network.

In some examples, a conflict resolution process may be implemented to confirm that the selected inference value of the configuration setting can be implemented, especially in view of other devices and values of configuration settings that were previously set. The conflict resolution process can help confirm that each of the inference values determined by the machine learning model is operable with other configuration settings. Based on the conflict resolution process, the value of the configuration setting may be implemented for the device. An integration stage can be executed to activate or install the value of the configuration setting on the device.

In some examples, the value for the configuration setting is suggested to the client when the estimated gain value exceeds a minimum threshold gain for the particular configuration setting. For example, the minimum threshold gain for bandwidth (first configuration setting) may be 15% minimum gain. In another example, the minimum threshold on gain for Wi-Fi speed for a new protocol IEEE 802.11ax (second configuration setting) may be 10% minimum gain. The estimated gain value may be compared to a minimum threshold gain for the operation of the network device in the network. When the estimated gain value exceeds the minimum threshold gain and the conflict resolution process is clear/satisfied, the values for each of the configuration settings that exceed the minimum threshold gain may be displayed at a user interface or implemented automatically on the network device.

In some examples, the value for the configuration setting is restricted from being suggested to the client when there are historical interoperability issues in the network data across various networks, despite the gain value for the particular configuration setting. For example, the historical interoperability issues may identify two configuration settings that are in conflict with each other (e.g., at the same device or different devices). The historical interoperability issues may be identified, for example, by implementing the values for the configuration settings at a different network in the past, detecting that the configuration setting(s) were reversed, and ceasing to detect the historical interoperability issues after the value for the configuration setting was reversed. The system may restrict providing the recommendation to help avoid interoperability issues in the network that were previously detected, despite the gain value for the particular configuration setting.

Technical improvements are realized throughout the disclosure. For example, the inference value determined by the machine learning model may be a newer version of the configuration setting for an expected better operation of the configuration. However, the system may prevent installation of the newer version based on the potential conflicts with the rest of the configurations/network. This allows the network devices to have the most optimized configuration settings without restricting the functionality of the network overall and potentially creating operability issues between the devices connected to the network.

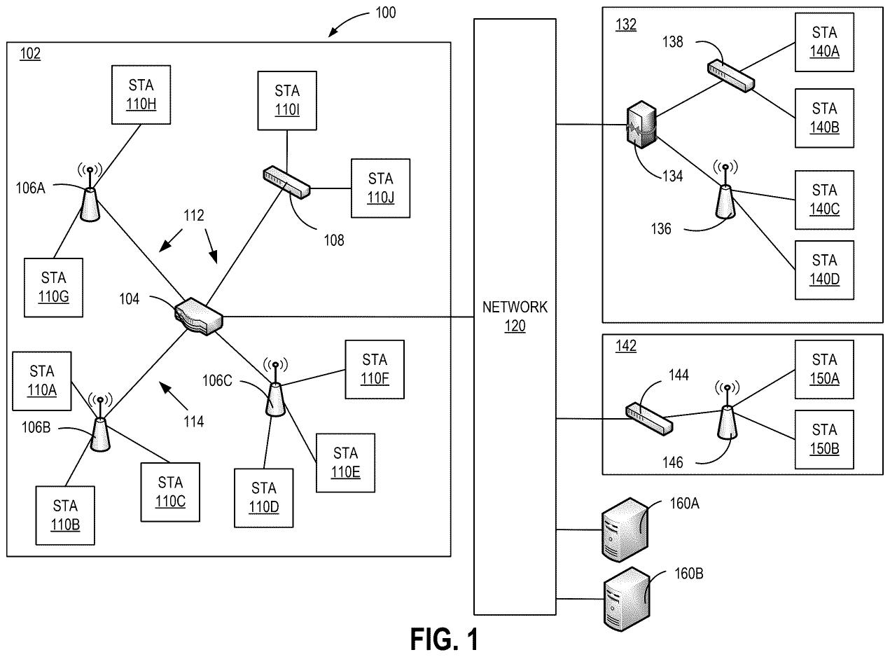

Before describing various examples of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility, or other organization. FIG. 1 illustrates an example of a configuration implemented with an organization having multiple users (or at least multiple client devices 110) and possibly multiple physical or geographical sites 102, 132, 142. Network configuration 100 may include primary site 102 in communication with network 120. Network configuration 100 may also include one or more remote sites 132, 142, that are in communication with the network 120 by transmitting data packets. A new device may be introduced to network 120 at any of sites 102, 132, 142 discussed herein. In some examples, the devices may be positioned at a same location of the entity.

Primary site 102 may include a primary network, which may be an office network, home network, or other network installation, for example. The primary network may be a private network, such as a network that may include security and access controls to restrict access to authorized users of the private network. Authorized users may include employees of a company at primary site 102, residents of a house, customers at a business, for example.

In the example of FIG. 1, primary site 102 includes controller 104, which is in communication with network 120. Controller 104 may provide communication with network 120 for primary site 102. There may be other points of communication with network 120 for primary site 102 in addition to controller 104. Although single device associated with controller 104 is illustrated, primary site 102 may include multiple controllers and/or multiple communication points with network 120. In some examples, controller 104 may communicate with network 120 through a router. In other examples, controller 104 provides router functionality to the devices in primary site 102. In this specification, the word “tunnel” refers to an encapsulated mode of transporting data between AP and controller.

Controller 104 may be operable to configure and manage network devices, such as at primary site 102, and may also manage network devices at remote sites 132, 142. Controller 104 may be operable to configure and/or manage switches, routers, access points, and/or client devices connected to a network. Controller 104 may itself be, or provide the functionality of, an Access Point (AP).

Controller 104 may be in communication with one or more switches 108 and/or wireless Access Points (APs) 106a-c. Switches 108 and wireless APs 106a-c provide network connectivity to various client devices 110a-j. Using a connection to switch 108 or AP 106a-c, client device 110a-j may access network resources, including other devices on the (primary site 102) network and network 120.

Examples of client devices may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

Within primary site 102, switch 108 is included as one example of a point of access to the network established in primary site 102 for wired client devices 110i-j. Client devices 110i-j may connect to switch 108 and through switch 108, may be able to access other devices within network configuration 100. Client devices 110i-j may also be able to access network 120, through switch 108. Client devices 110i-j may communicate with switch 108 over a wired or wireless connection 112. In the illustrated example, switch 108 communicates with controller 104 over a wired or wireless connection 112.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the example of FIG. 1, APs 106a-c can be managed and configured by controller 104. APs 106a-c communicate with controller 104 and the network over connections 112, which may be either wired or wireless interfaces.

Network configuration 100 may include one or more remote sites 132. Remote site 132 may be located in a different physical or geographical location from primary site 102. In some cases, remote site 132 may be in the same geographical location, or possibly the same building, as primary site 102, but lacks a direct connection to the network located within primary site 102. Instead, remote site 132 may utilize a connection over a different network, e.g., network 120. Remote site 132 such as the one illustrated in FIG. 1 may be a satellite office, another floor or suite in a building, for example. Remote site 132 may include gateway device 134 for communicating with network 120. Gateway device 134 may be a router, a digital-to-analog modem, a cable modem, a digital subscriber line (DSL) modem, or some other network device configured to communicate with network 120. Remote site 132 may also include switch 138 and/or AP 136 in communication with gateway device 134 over either wired or wireless connections. Switch 138 and AP 136 provide connectivity to the network for various client devices 140a-d.

In various examples, remote site 132 may be in direct communication with primary site 102, such that client devices 140a-d at remote site 132 access the network resources at primary site 102 as if these client devices 140a-d were located at primary site 102. In such examples, remote site 132 is managed by controller 104 at primary site 102, and controller 104 provides the necessary connectivity, security, and accessibility that enable the connection between remote site 132 and primary site 102. Once connected to primary site 102, remote site 132 may function as a part of a private network provided by primary site 102.

In various examples, network configuration 100 may include one or more smaller remote sites 142, comprising gateway device 144 for communicating with network 120 and wireless AP 146, by which various client devices 150a-b access network 120. Examples of remote site 142 may represent, for example, an individual employee's home or a temporary remote office. Remote site 142 may also be in communication with primary site 102, such that client devices 150a-b at remote site 142 access network resources at primary site 102 as if these client devices 150a-b were located at primary site 102. Remote site 142 may be managed by controller 104 at primary site 102 to make this transparency possible. Once connected to primary site 102, remote site 142 may function as a part of a private network provided by primary site 102.

Network 120 may be a public or private network, such as the Internet, or other communication network to allow connectivity among various sites 102, 132, 142 as well as access to servers 160a-b. Network 120 may include third-party telecommunication lines, such as phone lines, broadcast coaxial cable, fiber optic cables, satellite communications, cellular communications, and the like. Network 120 may include any number of intermediate network devices, such as switches, routers, gateways, servers, and/or controllers, which are not directly part of network configuration 100 but that facilitate communication between the various parts of the network configuration 100, and between the network configuration 100 and other network-connected entities. Network 120 may include various servers 160a-b. In an example, servers 160a-b may comprise content servers that include various providers of multimedia downloadable and/or streaming content, including audio, video, graphical, and/or text content, or any combination thereof. Examples of content servers 160a-b include web servers, streaming radio and video providers, and cable and satellite television providers. Client devices 110a-j, 140a-d, 150a-b may request and access the multimedia content provided by content servers 160a-b.

In another example, servers 160a-b can be the subject of configuration recommendations, where these devices transmit information within the network. In another example, servers 160a-b can maintain historical interoperability information that examples of the disclosed technology can leverage to make configuration recommendations.

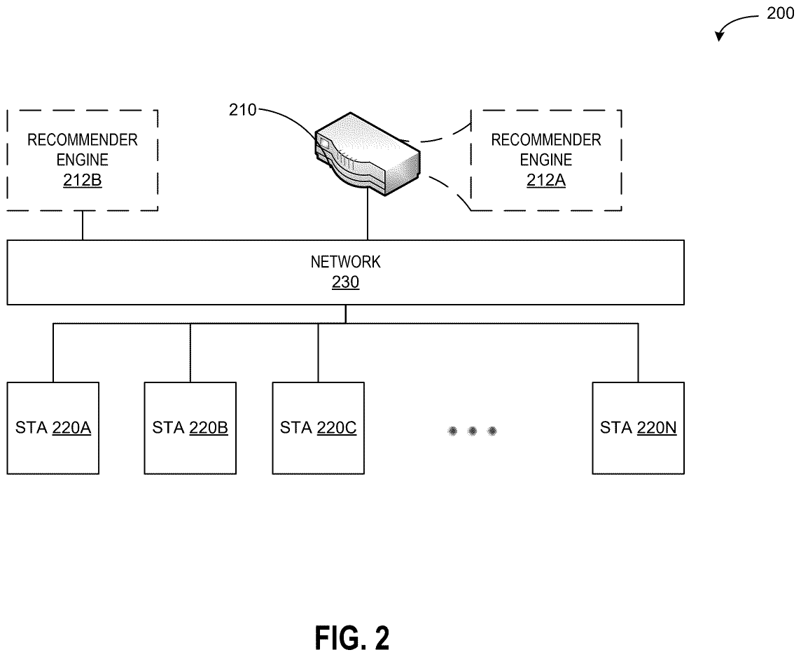

FIG. 2 illustrates a controller with recommendation engine in communication with a set of network devices, in accordance with some examples of the disclosure. In example 200, new device 210 is added to communication network 230 that supports communication for a set of network devices 220 (illustrated as first device 220A, second device 220B, third device 220C, and Nth device 220N). The set of network devices 220 may be configured using configuration settings that allow the devices to communicate with each other via network 230 or to external sources on a secondary network.

Network device 210 may comprise recommender engine 212 as a component of device 210 (as first implementation of recommender engine 212A) or may be implemented separately from network device 210, including at a controller in a cloud environment (as second implementation of recommender engine 212B). In these or other implementations, recommender engine 212 (e.g., implemented at network device 210 or at the controller) may receive data packets that are transmitted via network 230. Recommender engine 212 may analyze the data packets to determine the current configuration settings and devices of network 230. Data determined from the data packets may comprise configuration settings of the set of network devices 220 or other information associated with the network.

In some examples, recommender engine 212 may use data from the set of network devices 220 for training the machine learning models (e.g., determining an inference value from a trained machine learning model and estimating a gain value achieved from implementing the value for the configuration setting). The estimated gain value may be compared to a minimum threshold gain for the operation of the network device in the network. When the estimated gain value exceeds the minimum threshold gain, the recommender may select the particular inference value for the configuration setting. In some examples, the training process is implemented offline on a separate device without diverting from the essence of the disclosure.

In some examples, the gain value may be compared to a minimum threshold gain. For example, when the implementation of the value of the configuration setting does not have a large enough effect on the operation of the network device or the operation of the network overall, the recommendation for adjusting the value of the configuration setting may be prevented. As an illustration, the devices may be old (e.g., 10+ years old) and may be implemented in the network to serve a minor purpose. There may not be a strong enough use case for upgrading the device if it satisfies the purpose intended for installing the device in the network. In this example, the gain related to upgrading the device (e.g., faster transmission speeds) may not exceed the minimum threshold gain, and the recommendation may be prevented from being triggered/displayed.

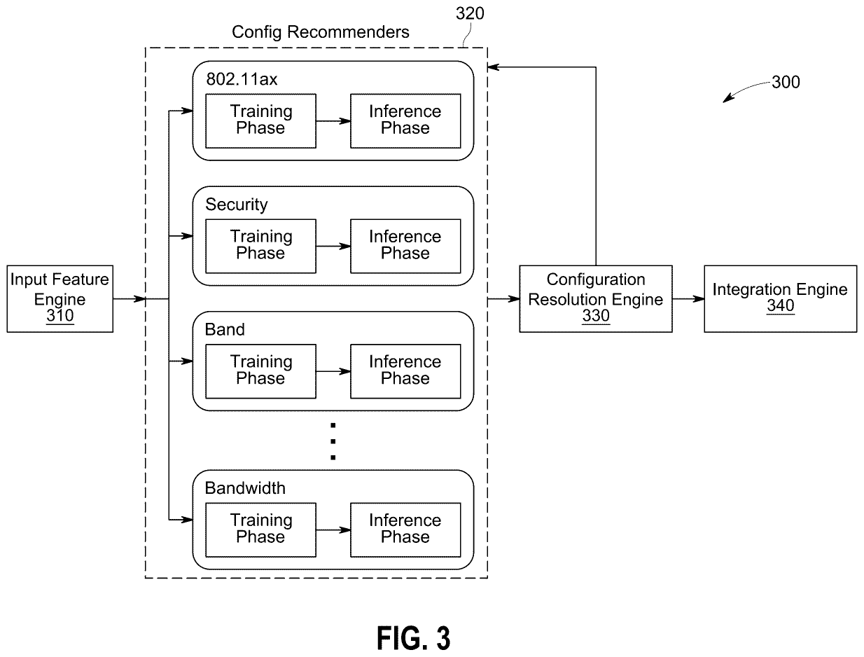

In some examples, recommender engine 212 may also use the data from the set of network devices 220 for determining historical interoperability issues after the inference value is deployed for the configuration setting on the device in the network. When a historical interoperability issue is identified across various networks, the values corresponding with the two configuration settings may be in conflict with each other and the value may be restricted from being recommended for the new device. Additional detail of recommender engine 212 is provided with FIG. 3.

Other implementations of the recommendation engine are conceived without diverting from the essence of the disclosure. For example, example 200 illustrates a recommendation process for networking devices connected to the network. The recommendation engine may also be implemented for a mobile phone or other device. In these examples, the recommendation engine can identify the type of network device that is communicated via the network and provide the recommendation or analysis results to a second network device that is controlling or supporting the network.

FIG. 3 is an illustrative process for determining the optimal configuration of a network device in accordance with some examples of the disclosure. In example 300, the illustrative process of determining the optimal configuration for the new network device is shown. For example, the new network device may be plugged into the network for a first time and a recommender engine, implemented at the new device or remotely at a controller in a cloud environment, may be executing the process illustrated herein.

At block 310, input features may be determined. For example, the input data may comprise data packets that are transmitted within the network. The data packets may comprise environmental features of devices in the network, including device model information (e.g., the type/model of access point implemented), firmware information (e.g., firmware version), current AP configuration information, or other information that can be derived from data packets. Input data may also comprise client specific features that may be determined from the data packets, including data bytes that are transmitted through the network, transmission rate, signal-to-noise (SNR) ratio, operating system (OS) type, or other information. In some examples, input data may comprise network configuration settings such as an identification of the communication protocol (e.g., IEEE 802.11ax protocol), security certification, radio frequency (RF) band, or operational bandwidth. Various other input features may be determined without diverting from the scope of the disclosure.

In some examples, the input features may be associated with a new device being plugged into the network where the network topology and communications are not previously known. For example, the input features may be determined absent an electronic handshake or authentication process between the devices in the network and a controller in a cloud environment. In these examples, the analysis of the data packets may be used absent pre-existing information of the network topology and existing devices.

In some examples, the analysis of the data packets may rely on real-time data from the network. The real-time data may help ensure that the packets being transmitted in the network are originating and being received by devices that are currently active in the network. This may help identify values for the configuration settings that are relevant to potential interoperability conflicts between the new device and pre-existing devices, and that may be resolved during the conflict resolution process described herein.

At block 320, individual features from the input data may be matched to a corresponding trained machine learning model for that configuration setting, and the input data may be provided as input to the model. For example, a feature from the network data may be matched to a trained machine learning model. An inference value may be generated as output from the trained machine learning model, which identifies a version or other value for the configuration setting.

Various illustrative examples exist. For example, the information identifying a communication protocol in the input data may be provided to a trained machine learning model for the communication protocol configuration setting. In another example, the information about the security configuration settings in the input data may be provided to a trained machine learning model for the security configuration settings. In another example, the radio band configuration setting in the input data may be provided to a trained machine learning model for the radio band configuration settings. In another example, the bandwidth configuration setting in the input data may be provided to a trained machine learning model for the bandwidth configuration setting.

In some examples, the trained machine learning models may be previously trained offline before they are provided with a recommender engine that can determine a recommended configuration setting for the network device. For example, the training process may select and prepare features for the trained model, so that the model can predict the target variable while accounting for respective configuration setting and other features. The most relevant features from the dataset may have the highest correlation to the inference value determination of the machine learning model. The training may also discard irrelevant or redundant features that may potentially introduce noise or overfitting.

In some examples, the training process may receive data from multiple client networks. The multiple networks may provide data that links the value of the configuration setting with the operability of the client devices in the client network. The training process may train the machine learning model to optimize the inference value corresponding with the configuration setting, where each machine learning model corresponds with a different configuration setting.

In some examples, the training process may statistically evaluate each feature and assign a gain score based on its correlation with the target variable (e.g., the final value/version for that particular configuration setting). The features of the trained machine learning model may be selected based on the gain score.

In some examples, the training process may evaluate different subsets of features using a predictive performance of the configuration setting in optimizing communication speed, lossless communication, and other features of the communication network determined by the machine learning model. The training process in this example may select features based on their contribution to improving the accuracy of the machine learning model.

In some examples, the training process may correspond with an embedded training. In this example, the training process may perform feature selection as part of the model training process itself by implementing a regression process or a decision tree based feature selection of the appropriate features in the trained model.

Once the machine learning models are trained, the trained machine learning model may determine/predict an inference value for the configuration setting of the network devices in the network. The predicted inference value may be applied to the configuration setting if it exceeds the minimum threshold gain for that configuration setting. For example, the minimum threshold gain for bandwidth (first configuration setting) may be 15% minimum gain (determined by the ML model) while the minimum threshold on gain for Wi-Fi speed for a new protocol IEEE 802.11ax (second configuration setting) may be 10% minimum gain. The estimated gain value may be compared to a minimum threshold gain for operation of the network device in the network.

At block 330, any predicted conflicts identified in values chosen for the configuration settings may be resolved. The configuration resolution may determine whether to update the new device with the predicted inference values for each configuration setting based on the absence of perceived conflicts. The inference values may be compared to multiple other values, including (1) values for other configuration settings in the current device, (2) values for configuration settings in other devices, and (3) values for configuration settings in devices in other networks.

In some examples, the system may compare the predicted inference value to values of other configuration settings in the current device. This determination may use real-time data to identify the settings of the current device. The comparison may help identify conflicts between the abilities of the current device and the predicted setting that the system is recommending. For example, this comparison may help identify hardware or software limitations of the device, including the operating system (OS) of the device, which may not be configured to allow the configuration setting to be set to the predicted value.

In some examples, the system may compare the predicted inference value to configuration settings in other devices. This determination may use real-time data to identify the settings of the current device. The comparison may help confirm that the current device is able to communicate along the same protocols that are supported by the other devices.

In some examples, the system may compare the predicted inference value to the configuration settings of other devices in other networks. This determination may use historical interoperability data to identify conflicts that may have occurred in association with the configuration settings of various devices. The comparison may help prevent conflicts between values of configuration settings that are identified in other networks.

At block 340, the value for the configuration setting may be installed on the network device. In some examples, the value for the configuration setting is restricted from being installed to the client when there are historical interoperability issues in the network data across various networks, despite the gain value for the particular configuration setting. For example, the integration engine may identify two configuration settings that are in conflict with each other once the inference value is deployed for the configuration setting at the device in the network. The system may restrict providing the recommendation may help avoid interoperability issues in the network that the other network may have experienced, despite the gain value for the particular configuration setting.

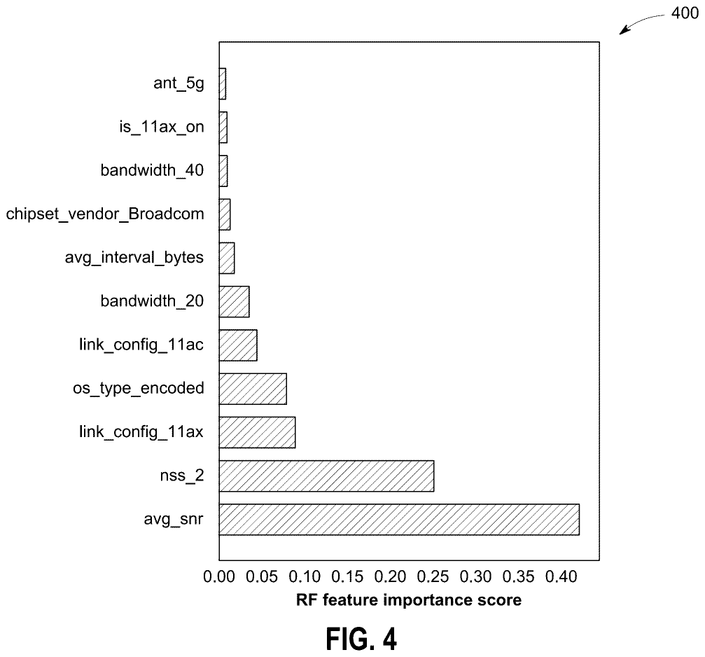

FIG. 4 illustrates a ranking of configuration settings for a network device, in accordance with some examples of the disclosure. In example 400, a feature importance ranking is provided for a radio frequency (RF) band score, where the trained machine learning model for the configuration setting (RF band) is compared with values for other configuration settings at the network device. The ranking shows the SNR, NSS, and 802.11ax client capability are associated with the highest gains in the prediction of the transmission rate for the network.

In this example, the RF band machine learning model may be trained using a random forest (RF) regressor model that learns the distribution of transmission rates during the training process. For example, during the training process, the machine learning model for this configuration setting may minimize the mean squared error (MSE) loss while controlling for environment and client-specific features such as SNR, NSS, client configuration capability, OS type, and bandwidth.

During the inference phase, the RF band machine learning model may receive the network data, generate an inference value, and predict a gain of operation with respect to the particular configuration setting (e.g., the RF band). As an illustrative example, the inference value prediction may include the IEEE 802.11ax value of the configuration setting. The system can initiate a conflict resolution process to determine historical interoperability issues while connecting to the network or communicating with other pre-existing devices. Based on the conflict resolution process, the value of the configuration setting may be prevented. In actuality, other devices have disabled the value, despite the high estimated gains from enabling the value for the configuration setting, due to the conflicts with other configuration settings (e.g., printer not being able to connect, etc.).

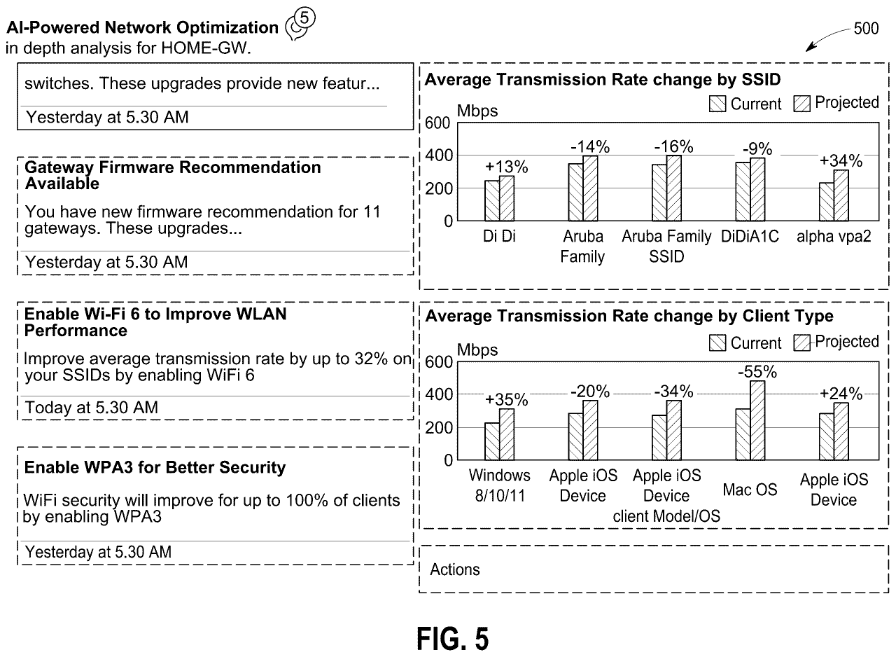

FIG. 5 is a user interface for providing a recommendation of a configuration setting for a network device, in accordance with some examples of the disclosure. In example 500, a user interface is illustrated to provide a recommendation of a configuration setting for network device. In examples where the recommendation is prevented or the installation is prevented, other recommendations may be provided to the user interface and the conflicting recommendation may not be displayed.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

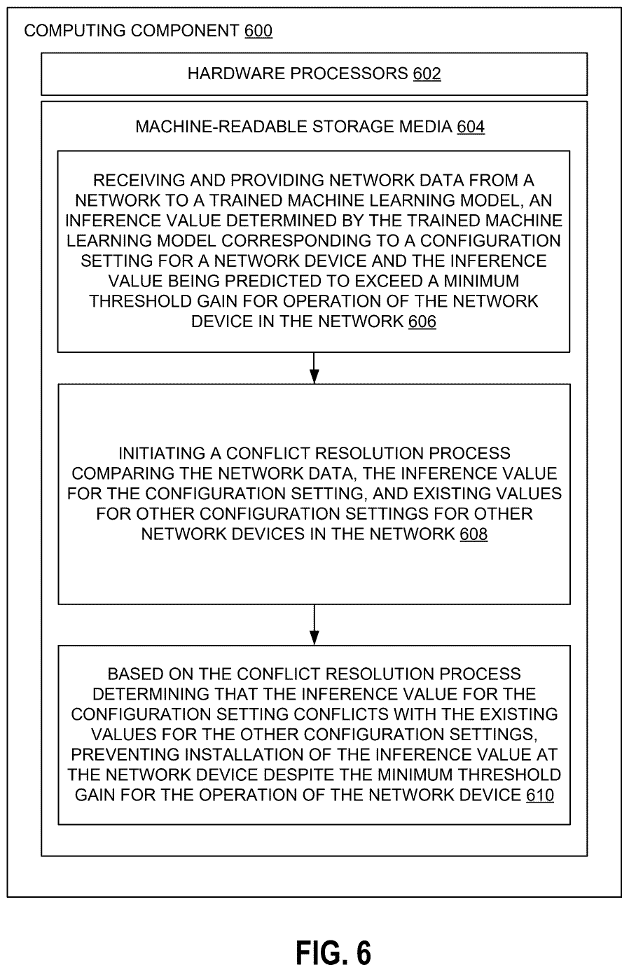

FIG. 6 illustrates a computing component that may be used to implement an AI-powered network configuration recommendation system, in accordance with various examples of the disclosed technology. For example, computing component 600 may be, for example, a server computer, a controller, or any other similar computing component capable of processing data. In the example implementation of FIG. 6, the computing component 600 includes hardware processor 602 and machine-readable storage medium 604.

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-610, to control processes or operations for an AI-powered network configuration recommendation system. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-610.

Hardware processor 602 may execute instruction 606 to receive and provide network data from a network to a trained machine learning model. The inference value determined by the trained machine learning model may correspond to a configuration setting for a network device.

The configuration setting/inference value may have various values. For example, the inference value may correspond with a version number or other value defining the type/model/version of the configuration setting. As an illustrative example, a “Wi-Fi protocol” configuration setting may correspond with “IEEE 802.11ax” or “IEEE 802.11ac” inference values. The inference values may be determined by the trained machine learning model that corresponds with the configuration setting. In another example, the “radio band” configuration setting may correspond with “2.4 GHz,” “5 GHz,” or “6 GHz” inference values.

When the trained machine learning model is executed, the machine learning model may use real-time data from the network to determine an inference value for a configuration setting of a device that has been added to the network. For example, the trained machine learning model can receive the data from the network (for the configuration setting) and provide it as input to the machine learning model that is tuned to optimize values associated with the particular configuration setting. The output of the machine learning model can suggest the inference value of the configuration setting that best works for the network.

In some examples, the inference value may be predicted to exceed a minimum threshold gain for operation of the network device in the network. The value for the configuration setting may be suggested to the client when the estimated gain value exceeds a minimum threshold gain for the particular configuration setting. For example, the minimum threshold gain for bandwidth (first configuration setting) may be 15% minimum gain. In another example, the minimum threshold on gain for Wi-Fi speed for a new protocol IEEE 802.11ax (second configuration setting) may be 10% minimum gain. The estimated gain value may be compared to a minimum threshold gain for the operation of the network device in the network. When the estimated gain value exceeds the minimum threshold gain and the conflict resolution process is clear/satisfied, the values for each of the configuration settings that exceed the minimum threshold gain may be displayed at a user interface or implemented automatically on the network device.

Hardware processor 602 may execute instruction 608 to initiate a conflict resolution process comparing the network data, the inference value for the configuration setting, and existing values for other configuration settings for other network devices in the network. For example, the conflict resolution process can help confirm that each of the inference values determined by the machine learning model is operable with other configuration settings.

Based on the conflict resolution process, in some examples, the value of the configuration setting may be implemented for the device. An integration stage can be executed to activate or install the value of the configuration setting on the device.

Hardware processor 602 may execute instruction 610 to prevent installation of the inference value at the network device despite the minimum threshold gain for the operation of the network device. In some examples, the prevention is based on the conflict resolution process determining that the inference value for the configuration setting conflicts with the existing values for the other configuration settings.

In some examples, the value for the configuration setting is restricted from being suggested to the client when there are historical interoperability issues in the network data across various networks, despite the gain value for the particular configuration setting. For example, the historical interoperability issues may identify two configuration settings that are in conflict with each other (e.g., at the same device or different devices). The historical interoperability issues may be identified, for example, by implementing the values for the configuration settings at a different network in the past, detecting that the configuration setting(s) were reversed, and ceasing to detect the historical interoperability issues after the value for the configuration setting was reversed. The system may restrict providing the recommendation to help avoid interoperability issues in the network that were previously detected, despite the gain value for the particular configuration setting.

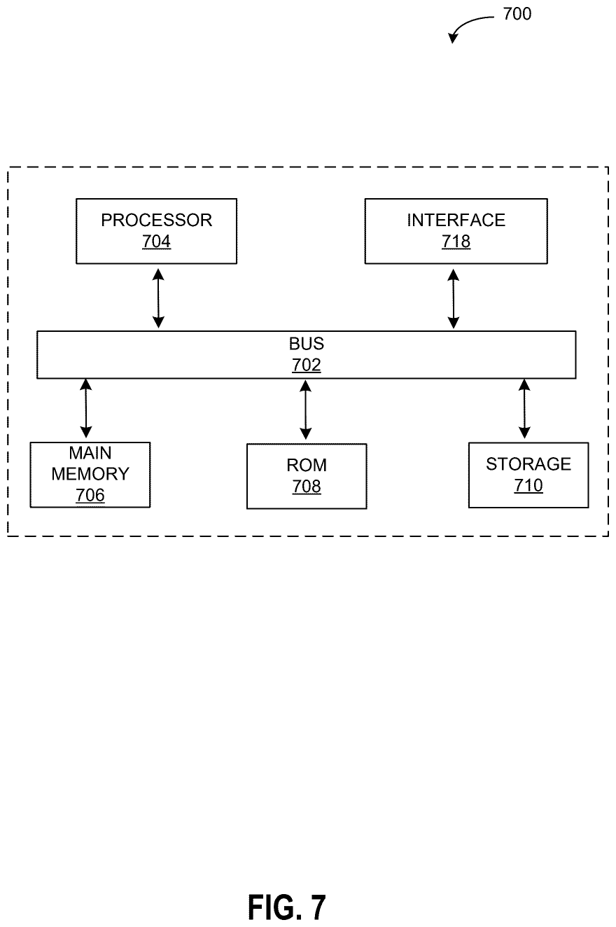

FIG. 7 depicts a block diagram of an example computer system 700 in which various examples of the disclosed technology described herein may be implemented. Computer system 700 includes bus 702 or other communication mechanism for communicating information, one or more hardware processors 704 coupled with bus 702 for processing information. Hardware processor(s) 704 may be, for example, one or more general purpose microprocessors.

Computer system 700 also includes main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes read only memory (ROM) 708 or other static storage device coupled to bus 702 for storing static information and instructions for processor 704. Storage device 710, such as a magnetic disk, optical disk, or USB thumb drive (Flash drive), etc., is provided and coupled to bus 702 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 700 may implement the techniques described herein using customized hard-wired logic, one or more ASICs or FPGAs, firmware and/or program logic which in combination with the computer system causes or programs computer system 700 to be a special-purpose machine. According to one example of the disclosed technology, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

Computer system 700 also includes interface 718 coupled to bus 702. Interface 718 provides a two-way data communication coupling to one or more network links that are connected to one or more local networks. For example, interface 718 may be an integrated services digital network (ISDN) card, cable modem, satellite modem, or a modem to provide a data communication connection to a corresponding type of telephone line. As another example, interface 718 may be a local area network (LAN) card to provide a data communication connection to a compatible LAN (or WAN component to communicate with a WAN). Wireless links may also be implemented. In any such implementation, interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 718, which carry the digital data to and from computer system 700, are example forms of transmission media.

Computer system 700 can send messages and receive data, including program code, through the network(s), network link and interface 718. In the Internet example, a server might transmit a requested code for an application program through the Internet, the ISP, the local network and interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method comprising:
receiving and providing network data from a network to a trained machine learning model, an inference value determined by the trained machine learning model corresponding to a configuration setting for a network device and the inference value being predicted to exceed a minimum threshold gain for operation of the network device in the network;
initiating a conflict resolution process comparing the network data, the inference value for the configuration setting, and existing values for other configuration settings for other network devices in the network; and
based on the conflict resolution process determining that the inference value for the configuration setting conflicts with the existing values for the other configuration settings, preventing installation of the inference value at the network device despite the minimum threshold gain for the operation of the network device.

2. The computer-implemented method of claim 1, further comprising:
based on data from a second network that is unrelated to the network, training the trained machine learning model corresponding to the inference value for the configuration setting.

3. The computer-implemented method of claim 1, further comprising:
prior to receiving the trained machine learning model, determining a set of configuration settings implemented at the network device; and
selecting the trained machine learning model associated with an existing setting in the set of configuration settings implemented at the network device.

4. The computer-implemented method of claim 1, wherein the network device is an access point (AP).

5. The computer-implemented method of claim 1, wherein the network device is a switch.

6. The computer-implemented method of claim 1, wherein the network device corresponds with a set of configuration settings and each of the set of configuration settings corresponds with a unique trained machine learning model for a single configuration setting.

7. The computer-implemented method of claim 1, wherein the inference value corresponds with a software application version.

8. The computer-implemented method of claim 1, wherein the inference value corresponds with a frequency value for a radio band.

9. The computer-implemented method of claim 1, wherein the inference value corresponds with a version of a communication protocol.

10. A computer system comprising:
a memory storing instructions; and
a processor communicatively coupled to the memory and configured to execute the instructions to:
receive and provide network data from a network to a trained machine learning model, an inference value determined by the trained machine learning model corresponding to a configuration setting for a network device and the inference value being predicted to exceed a minimum threshold gain for operation of the network device in the network;
initiate a conflict resolution process comparing the network data, the inference value for the configuration setting, and existing values for other configuration settings for other network devices in the network; and
based on the conflict resolution process determining that the inference value for the configuration setting conflicts with the existing values for the other configuration settings, prevent installation of the inference value at the network device despite the minimum threshold gain for the operation of the network device.

11. The computer system of claim 10, wherein the processor is further configured to execute the instructions to:
based on data from a second network that is unrelated to the network, train the trained machine learning model corresponding to the inference value for the configuration setting.

12. The computer system of claim 10, wherein the processor is further configured to execute the instructions to:
prior to receiving the trained machine learning model, determine a set of configuration settings implemented at the network device; and
select the trained machine learning model associated with an existing setting in the set of configuration settings implemented at the network device.

13. The computer system of claim 10, wherein the network device is an access point (AP).

14. The computer system of claim 10, wherein the network device is a switch.

15. The computer system of claim 10, wherein the network device corresponds with a set of configuration settings and each of the set of configuration settings corresponds with a unique trained machine learning model for a single configuration setting.

16. The computer system of claim 10, wherein the inference value corresponds with a software application version.

17. The computer system of claim 10, wherein the inference value corresponds with a frequency value for a radio band.

18. The computer system of claim 10, wherein the inference value corresponds with a version of a communication protocol.

19. A non-transitory computer-readable storage medium storing a plurality of instructions executable by a processor, the plurality of instructions when executed by the processor cause the processor to:
receive and provide network data from a network to a trained machine learning model, an inference value determined by the trained machine learning model corresponding to a configuration setting for a network device and the inference value being predicted to exceed a minimum threshold gain for operation of the network device in the network;
initiate a conflict resolution process comparing the network data, the inference value for the configuration setting, and existing values for other configuration settings for other network devices in the network; and
based on the conflict resolution process determining that the inference value for the configuration setting conflicts with the existing values for the other configuration settings, prevent installation of the inference value at the network device despite the minimum threshold gain for the operation of the network device.

20. The non-transitory computer-readable storage medium of claim 19, the processor further caused to:
prior to receiving the trained machine learning model, determine a set of configuration settings implemented at the network device; and
select the trained machine learning model associated with an existing setting in the set of configuration settings implemented at the network device.
